(19) United States
(12) Patent Application Publication
(10) Pub. No.: US 2014/0259921 A1
(43) Pub. Date: Sep. 18, 2014

(54) Aquaponic System

(71) Applicants: Kaben Lynn Smallwood, Talihina, OK (US); Shelby Lee Smallwood, Norman, OK (US); Keith Richard Scott, Oklahoma City, OK (US)

(72) Inventors: Kaben Lynn Smallwood, Talihina, OK (US); Shelby Lee Smallwood, Norman, OK (US); Keith Richard Scott, Oklahoma City, OK (US)

(21) Appl. No.: 14/206,367

(22) Filed: Mar. 12, 2014

Related U.S. Application Data
(60) Provisional application No. 61/791,488, filed on Mar. 15, 2013.

(51) Int. Cl. A01G 31/02

(52) U.S. Cl. CPC A01G 31/02
USPC 47/62 R; 47/59 R

(57) ABSTRACT

An aquaponic system for growing organic materials and farming fish comprising a grow bed, a piping system, and a tank. The grow bed is filled with media. Water fills the grow bed via a water-in piping system. Water drains from the grow bed via a water-out piping system. Water drained from the grow bed will be directed into a tank filled with aquatic organisms. The aquatic organisms with create nutrient-rich organic waste that mixes with the water in the tank. The nutrient-rich water is directed from the tank, through a filter, and into the water-in piping system. The water-in piping system directs the water into the grow bed. The organic materials in the grow bed absorb the nutrients and naturally filter the organic waste from the water. The filtered water is directed back into the fish tank. The circulation of water through the system is then repeated as many times as desired.

### CROSS REFERENCE TO RELATED APPLICATION

This application claims the benefit of provisional patent application Ser. No. 61/791,488, filed on Mar. 15, 2013, the entire contents of which are incorporated herein by reference.

### FIELD

The present invention relates generally to self-contained systems and methods used to combine plant and fish growth.

### SUMMARY

The present invention is directed to an aquaponic system comprising a grow bed, media for growing organic materials within the grow bed, a piping system connected to the grow bed, a tank containing aquatic organisms, and a pump. The piping system comprises a water-in section and a water-out section. The water-in section provides nutrient-rich water to the grow bed and the water-out section drains filtered water from the grow bed. The pump is used to pump water from the water-out section to the tank and back into the piping system.

The present invention is also directed to an aquaponic system comprising a plurality of tubs. Each of the plurality of tubs comprises media contained within the tub for growing organic materials, a plurality of conduits for supplying water comprising nutrients to each of the plurality of tubs, and a plurality of siphons for draining filtered water from each of the plurality of tubs. The aquaponic system also comprises a water-in piping system connected to each of the plurality of conduits, a water-out piping system connected to each of the plurality of siphons, a tank containing aquatic organisms, and a filter. Water is circulated from the water-in piping system to the plurality of tubs to the water-out piping system to the tank through the filter and back into the water-in piping system.

The present invention is further directed to a method for growing organic materials in an aquaponic system. The method comprises the steps of filling a tub with media, placing organic materials in the media, filling the tub with water comprising nutrient-rich organic waste from a water-in piping system, growing organic materials in the media contained within the tub by fertilizing the organic materials with the nutrient-rich organic waste, and filtering the water comprising the nutrient-rich organic waste by allowing the organic materials to absorb the nutrient-rich organic waste. The method further comprises the steps of draining the filtered water from the tub and into a water-out piping system, directing the filtered water through the water-out piping system and into a tank containing aquatic organisms producing nutrient-rich organic waste; and directing water comprising the nutrient-rich organic waste from the tank and back into the water-in piping system.

### BRIEF DESCRIPTION OF THE DRAWINGS

FIG. 1 is a diagram of an aquaponic system.

FIG. 2 is an illustration of a grow bed and a piping system of the aquaponic system.

FIG. 3 is an exploded view of a siphon shown in FIG. 2.

FIG. 4 is an illustration of a plurality of grow beds for use with the aquaponic system.

FIG. 5 is an illustration of a receptacle for use with the aquaponic system.

FIG. 6 is an illustration of a tank comprising aquatic organisms for use with the aquaponic system.

FIG. 7 is a flowchart depicting a method for growing organic materials and farming aquatic organisms using the aquaponic system.

### DESCRIPTION

Aquaponics is the combination of fish farming and the growing of plants without the use of soil. The organic waste from the fish creates a nutrient-rich water that serves as a natural fertilizer for growing plants. The plants naturally purify the water as they consume the nutrient-rich organic waste from the fish. The fish waste provides a food source for the growing plants and the plants provide a natural filter for the fish water. This creates a sustainable ecosystem for both the plants and fish to thrive.

Turning now the figures and first to FIG. 1, a diagram of an aquaponic system 8 is shown therein. The aquaponic system 8 comprises a grow bed or tub 10, a piping system 22, a receptacle 54, a tank 60, and a filter 68. The piping system 22 comprises a water-in piping system or a water-in section 24, a water-out piping system or water-out section 26, a first transfer pipe 58, and a second transfer pipe 66. In operation, water travels from the water-in piping system 24 to the grow bed 10. Water is drained from the grow bed 10 via the water-out piping system 26 and is directed into the receptacle 54. Water from the receptacle 54 is directed to the tank 60 via the first transfer pipe 58. The second transfer pipe 66 directs water from the tank 60 into the filter 68. After water passes through the filter 68, it is directed back into the water-in piping system 24.

Referring now to FIG. 2, the grow bed 10 of the aquaponic system 8 is shown in more detail. The grow bed 10 comprises a bottom 14 underneath the grow bed 10, and a base (not shown) inside of the grow bed. The grow bed 10, as shown, is elevated off of the ground surface by a pair of legs 16. FIG. 2 shows the grow bed 10 filled with media 18. The media 18 may comprise a mixture of expanded clay and expanded shell. This form of media is created by firing clay and shell at extremely hot temperatures to remove any water and to make the clay and shell more porous. The more porous the clay and shell, the more able it is to soak up any water contained within the grow bed 10. The media 18 may also comprise other mixtures known in the art for use with aquaponics. The grow bed 10 may be filled to any desired height with the media 18. The media 18 is supported on the base inside of the grow bed 10.

A plurality of organic materials 20 are also shown growing from the media 18 in FIG. 2. The organic materials 20 may comprise any form of plant species desired to be grown using the aquaponic system 8, such as fruiting plants. The organic materials 20 start out as immature seeds and eventually grow into mature plants, as shown in FIG. 2. The grow bed 10 may be of any shape and size as long as it is capable of housing media 18, organic materials 20, and water.

Continuing with FIG. 2, the piping system 22 of the aquaponic system 8 is shown beneath the grow bed 10. The piping system 22 is used to direct water or fluids into and out of the grow bed 10 and throughout the aquaponic system 8, FIG. 2 shows the water-in piping system 24 and the water-out piping system 26. The water-in piping system 24 directs water into the grow bed 10. The water-out piping system 26 drains water from the grow bed 10. The grow bed 10 also comprises a conduit 28. The conduit 28 projects upwards from the base inside of the grow bed 10 and is either attached to or engaged with a water-in coupler 30 located at or attached to the bottom 14 of the grow bed 10. The conduit 28 may also be integral with the water-in coupler 30. The water-in coupler 30 is connected to the water-in piping system 24. In operation, water from the water-in piping system 24 is directed into the water-in coupler 30 and into the conduit 28. The conduit 28 is open on an end 32 such that water flows out from the conduit and into the grow bed 10. Water may continue to be supplied to the grow bed 10 via the conduit 28 until the grow bed 10 is filled to a desired height.

The water-in coupler 30 comprises a valve connected to a handle 34. The water-in coupler 30 therefore controls the amount of water being supplied from the water-in piping system 24 to the grow bed 10. The valve may be opened or closed using the handle 34. The conduit 28 may alternatively comprise a sprinkler (not shown) to supply water to the grow bed 10. One of skill in the art will also recognize that the valve may be placed at any point along the water-in piping system 24 to control the amount of water being supplied to the grow bed 10. The valve may also be placed in the conduit 28 or the sprinkler.

Continuing with FIG. 2, the grow bed 10 also comprises a siphon 36. The siphon 36 projects upwards from the base inside of the grow bed 10 and is either attached to or engaged with a water-out coupler 38 located at or attached to the bottom 14 of the grow bed 10. The siphon 36 may also be integral with the water-out coupler 38. The water-out coupler 38 is connected to the water-out piping system 26. In operation, water contained within the grow bed 10 enters the siphon 36 which drains the water into the water-out coupler 38 and into the water-out piping system 26.

Referring now to FIG. 3, the siphon 36 is shown in more detail. The siphon 36 comprises an extension coupling 40, a container 42, and a filter 52. The extension coupling 40 comprises a bottom 44, an outer tube 47, and an inner passage (not shown). The outer tube 47 comprises a plurality of slits 46. The inner passage of the extension coupling 40 opens into the water-out coupler 38 (FIG. 2). The slits 46 may be opened or closed to allow water into the inner passage and into the water-out coupler 38 (FIG. 2), An operator may open or close specific slits 46 upon extension and retraction of the extension coupling 40 in order to control the height of water within the grow bed 10 before water begins to drain from the grow bed. The higher the open slits 46 on the extension coupling 40, the more water will be filled in the grow bed 10 before the grow bed begins to drain. In contrast, the lower the open slits 46 on the extension coupling 40 the less water will be filled in the grow bed 10 before the grow bed begins to drain.

Continuing with FIG. 3, the container 42 of the siphon 36 comprises a bottom 48 and a plurality of notches 50. The plurality of notches 50 are formed around the bottom 48 of the container 42. The container 42 fits over the extension coupling 40. In operation, water in the grow bed 10 flows through the notches 50 at the base 48 of the container 42 and begins to fill the container 42. Once the water reaches an open slit 46 in the extension coupling 40, it will drain into the inner passage, into the water-out coupler 38, and into the water-out piping system 26. The filter 52 may also be placed around the siphon 36. The filter 52 prevents any media 18 from draining through the siphon 36 and into the water-out piping system 26. Other variations of the siphon 36 known in the art may be used to drain water from the grow bed 10. One such variation is to simply have a small hole on the base of the grow bed 10 that opens into the water-out coupler 38.

Referring now to FIG. 4, the aquaponic system 8 comprises the grow bed 10 and a like grow bed 10a, The like grow bed 10a comprises a like conduit 28a and a like siphon 36a. The like grow bed 10a is connected via a like water-in coupler 30a to the same water-in piping system 24 that the conduit 28 is connected to. Thus, water flowing into the water-in piping system 24 may fill both the grow bed 10 and the like grow bed 10a at substantially the same time. Similarly, the like grow bed 10a is connected via a like water-out coupler 38a to the same water-out piping system 26 that siphon 36 is connected to. Thus, water draining from the grow bed 10 is mixed with water draining from the like grow bed 10a.

Continuing with FIG. 4, the aquaponic system 8 may comprise more than just one or two grow beds 10. The aquaponic system 8 may comprise a plurality of grow beds 10 or 10a that may be lined up side-by-side, end-to-end, proximate one another, or any combination of the before. The plurality of grow beds 10 may be configured such that they all use the same piping system 22 to supply water to the grow beds 10 and to drain water from the grow beds, as shown in FIG. 3. The grow beds 10 are connected to the water-in piping system 24 and the water-out piping system 26 via a plurality of water-in and water-out couplers 30 or 30a and 38 or 38a. The slits 46 on the extension couplings 40 (FIG. 3) of the siphons 36 or 36a may be opened at different heights in order to fill the grow beds 10 with varying amounts of water. This may be necessary because some organic materials 20 may require more water than others to grow. Similarly, the valves connected to the handles 34 on the water-in couplers 30 may be opened to different extents to allow water to flow into the grow beds 10 at different rates. The piping system 22 in FIG. 4 is located underneath the grow beds 10. However, one of skill in the art will recognize that the piping system 22 may be located to the side or above the grow beds 10. Alternatively, the piping system 22 may also be buried underground.

Turning now to FIG. 5, the receptacle 54 is shown. The receptacle 54 is used to house water draining from the water-out piping system 26. As water is drained from the grow bed 10 or the plurality of grow beds 10 (FIG. 4), it will flow through the water-out piping system 26 and into the receptacle 54. The receptacle 54 may comprise any shape and size as long as it is capable of housing water. The receptacle 54 may be positioned at a height lower than the height of the grow beds 10 in order to allow water to gravitationally drain from the water-out piping system 26 into the receptacle 54. A first pump 56 is contained within the receptacle 54. The first transfer pipe 58 is connected to the first pump 56. The first pump 56 pumps water from the receptacle 54 and into the first transfer pipe 58. The first transfer pipe 58 then directs water into the tank 60 (FIG. 6).

Referring now FIG. 6, the tank 60 containing aquatic organisms 62 is shown. The aquatic organisms 62 may be any species of fish or aquatic organisms desired to be farmed or known in the art for use with aquaponic systems. The aquatic organisms 62 create nutrient-rich organic waste that mixes with the water in the tank 60, The tank 60 may comprise any shape and size as long as it is capable of housing aquatic organisms 62. Water is directed into the tank 60 from the first transfer pipe 58. Alternatively, water may also drain into the tank 60 directly from the water-out piping system 26 (FIG. 2). The tank 60 comprises a second pump 64. The second pump 64 is connected to the second transfer pipe 66. The second pump 64 pumps water from the tank 60 into the second transfer pipe 66. The second transfer pipe 66 directs the water into the filter 68. The filter 68 removes any unwanted particles from the water and allows the water comprising the nutrient-rich organic waste to pass through. After water passes through the filter 68 water then returns into the water-in piping system 24 where it is supplied back to the grow beds 10.

In an alternative embodiment (not shown), water may also be directed back into the tank 60 after it passes through the filter 68. This may be accomplished by splitting the water-in piping system 24 into two sections after the filter 68. One section would go back to the tank 60, and one section would continue to the water-in piping system 24. A valve may be placed on each pipe section to divert the water to the tank 60, to the water-in piping system 24, or to both simultaneously.

Referring to both FIGS. 5 and 6, water may be pumped from the receptacle 54 to the tank 60 and back into the water-in piping system 24 via the use of only the first pump 56. Alternatively, water may also be pumped from the receptacle 54 to either the tank 60 or the water-in piping system 24 via the use of only the first pump 56. The tank 60 may be located inside the green house (not shown) or other housing used to contain the aquaponic system 8. Alternatively, the tank 60 may be placed outside of the green house or other housing.

Turning to FIG. 7, the steps for growing organic materials 20 and farming aquatic organisms 62 using the aquaponic system 8 is shown. In operation, the operator will fill the plurality of grow beds 10 with media 18 (Step 100). The grow beds 10 may be filled to any desired height with media 18. The operator will then place the desired organic materials 20 or seeds of the desired organic materials 20 in the media 18 (Step 102). Water may then be supplied to the water-in piping system 24. Water will flow through the water-in piping system 24 until it is directed by the plurality of water-in couplers 30 into the plurality of conduits 28. Water will flow through the conduits 28 and into the grow beds 10. Water will continue to flow into the grow beds 10 until the grow beds 10 have been filled to a desired height with water (Step 104). The organic materials 20 will absorb the nutrient-rich organic waste created by the aquatic organisms 62 that is contained within the water (Step 106), The nutrient-rich organic waste serves as a fertilizer for the organic materials 20, helping them to grow. By absorbing the nutrient-rich organic waste, the organic materials 20 naturally filter the water supplied by the water-in piping system 24. The operator may control the amount of water flowing into the grow beds 10 by manipulating the handles 34 connected to the valves formed within the water-in couplers 30. The valves may also be controlled via the use of a computerized timer (not shown). The computerized timer will open and close specified valves at specified times.

Once there is water contained within the grow beds 10 the siphons 36 will begin to pull water through the notches 50 at the base of the containers 42. Water will not start to drain until it has reached the height of the open slits 46 on the extension couplings 40 within the container 42. The filtered water passing through the slits 46 will drain into the water-out couplings 38 and into the water-out piping system 26 (Step 108). Water draining from each of the grow beds 10 will mix together within the water-out piping system 26 and flow via gravity, into the receptacle 54. Water in the receptacle 54 will then be pumped into the tank 60. However, the water may also be drained directly into the tank 60 from the water-out piping system 26 (Step 110). The filtered water provides the aquatic organisms 62 with clean water to live in.

Continuing with FIG. 7, the aquatic organisms 62 or fish contained within the tank 60 will create organic waste that mixes with the filtered water supplied to the tank (Step 112). The nutrient-rich water will then be pumped from the tank 60 and into the filter 68. The filter 68 will remove any unwanted particles from the water. The nutrient-rich water will then be sent back into the water-in piping system 24 to be supplied back to the grow beds (Step 114). All or a portion of the water may be diverted back into the tank 60 if desired. The water circulation process is repeated until the organic materials 20 are harvested and new organic materials are introduced into the aquaponic system 8. This process creates a sustainable ecosystem for both the plants and fish to thrive. The aquatic organisms 62 create food for the organic materials 20 and the organic materials 20 provide clean water for the aquatic organisms 62 to live. When the aquaponic system 8 is initially set-up, water may be circulated through the system several times before the organic materials 20 are introduced.

Various modifications can be made in the design and operation of the present invention without departing from its spirit. Thus, while the preferred construction and modes of operation of the invention have been explained in what is now considered to represent its best embodiments, it should be understood that within the scope of the appended claims, the invention may be practiced otherwise than as specifically illustrated and described.

What is claimed is:

1. An aquaponic system comprising:
a grow bed;
media for growing organic materials within the grow bed;
a piping system connected to the grow bed, the piping system comprising a water-in section and a water-out section; wherein the water-in section provides nutrient-rich water to the grow bed and the water-out section drains filtered water from the grow bed;
a tank containing aquatic organisms; and
a pump for pumping water from the water-out section to the tank and back into the piping system.

2. The aquaponic system of claim 1 further comprising a second pump for pumping water from the tank back into the piping system.

3. The aquaponic system of claim 2 wherein the second pump is contained within the tank.

4. The aquaponic system of claim 1 wherein the piping system is located underneath the grow bed.

5. The aquaponic system of claim 1 further comprising:
a second grow bed filled with media for growing organic materials;
wherein the piping system is connected to the second grow bed;
and wherein the water-in section provides nutrient-rich water to the second grow bed and the water-out section drains filtered water from the second grow bed.

6. The aquaponic system of claim 5 wherein the piping system is located underneath the second grow bed.

7. The aquaponic system of claim 1 further comprising a receptacle positioned below the height of the grow bed for collecting water from the water-out section of the piping system.

8. The aquaponic system of claim 7 wherein the pump is contained within the receptacle.

9. The aquaponic system of claim 1 wherein the media comprises expanded clay and expanded shell,

10. The aquaponic system of claim 1 wherein the water-out section comprises a siphon contained within the grow bed for draining water from the grow bed.

11. The aquaponic system of claim 10 wherein the siphon comprises an extension coupling and a container.

12. The aquaponic system of claim 11 wherein a plurality of notches are formed at the base of the container.

13. The aquaponic system of claim 1 wherein the water-in section of the piping system comprises a valve for controlling the amount of water supplied to the grow bed.

14. An aquaponic system comprising:
a plurality of tubs each comprising:
media contained within the tub for growing organic materials;
a plurality of conduits for supplying water comprising nutrients to each of the plurality of tubs; and
a plurality of siphons for draining filtered water from each of the plurality of tubs;
a water-in piping system connected to each of the plurality of conduits;
a water-out piping system connected to each of the plurality of siphons;
a tank containing aquatic organisms; and
a filter;
wherein water is circulated from the water-in piping system to the plurality of tubs to the water-out piping system to the tank through the filter and back into the water-in piping system.

15. The aquaponic system of claim 14 wherein the media comprises expanded clay and expanded shell.

16. The aquaponic system of claim 14 wherein the piping system is located underneath one of the plurality of tubs.

17. The aquaponic system of claim 14 further comprising a receptacle positioned below the height of the plurality of tubs for collecting water from the water-out piping system.

18. The aquaponic system of claim 14 wherein the water-in piping system comprises a valve for controlling the amount of water supplied to one of the plurality of tubs.

19. A method for growing organic materials in an aquaponic system comprising the steps of:
filling a tub with media;
placing organic materials in the media;
filling the tub with water comprising nutrient-rich organic waste from a water-in piping system;
growing organic materials in the media by fertilizing the organic materials with the nutrient-rich organic waste;
filtering the water comprising the nutrient-rich organic waste by allowing the organic materials to absorb the nutrient-rich organic waste;
draining the filtered water from the tub and into a water-out piping system;
directing the filtered water through the water-out piping system and into a tank containing aquatic organisms producing nutrient-rich organic waste; and
directing water comprising the nutrient-rich organic waste from the tank and back into the water-in piping system.

20. The method of claim 19 further comprising placing the water-in piping system underneath the tub.

21. The method of claim 19 further comprising placing the water-out piping system underneath the tub.

22. The method of claim 19 further comprising directing water into a receptacle positioned below the height of the tub before directing water into the tank.

23. The method of claim 19 further comprising filtering the water comprising the nutrient-rich organic waste from the tank before directing it to the water-in piping system.

24. The method of claim 19 further comprising controlling the amount of water supplied to the tub by manipulating a valve connected to the water-in piping system.

25. The method of claim 19 further comprising the steps of:
filling a plurality of tubs with media for growing organic materials;
filling the plurality of tubs with water comprising nutrient-rich organic waste from the water-in piping system; and
draining filtered water from the plurality of tubs and into the water-out piping system.
